(19) United States
(12) Patent Application Publication
(10) Pub. No.: US 2008/0082435 A1
(43) Pub. Date: Apr. 3, 2008

(54) RATIO INDEX

(76) Inventors: JOHN O'BRIEN, CORONA DEL MAR, CA (US); KE TANG, CAMBRIDGE (GB); DANIEL JACK RANSENBERG JR., SAUSALITO, CA (US); SAKHAWAT M. KHAN, ATHERTON, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/853,750

(22) Filed: Sep. 11, 2007

Related U.S. Application Data
(60) Provisional application No. 60/843,976, filed on Sep. 12, 2006.
(60) Provisional application No. 60/881,934, filed on Jan. 23, 2007.

(51) Int. Cl. G06Q 40/00

(52) U.S. Cl. 705/35

(57) ABSTRACT

In certain embodiments, a computer-implemented method of comparing financial parameters includes providing a first value representing at least a first financial parameter, providing a second value representing at least a second financial parameter, and calculating in a computer a ratio index comprising a time sequence of the ratio of the first value to the second value. In some embodiments, the method further includes creating a financial instrument, wherein the price of the financial instrument is based at least in part on the ratio index. In one embodiment, the financial instrument is an asset-liability derivative having an underlying comprising the ratio index.

### CROSS-REFERENCE TO RELATED APPLICATIONS

This application claims priority from U.S. Provisional Application No. 60/843,976 filed Sep. 12, 2006, entitled “The Ratio Index,” which is incorporated herein by reference in its entirety. This application also claims priority from U.S. Provisional Application No. 60/881,934 filed Jan. 23, 2007, entitled “The Ratio Index,” which is also incorporated herein by reference in its entirety.

### BACKGROUND

### Description of the Related Technology

Determining the best mix of investment assets to meet a future need is a challenge faced by many individuals, corporations, and charitable institutions. A simple example illustrating the general problem is a family wishing to provide for the college education of a child. Other examples include a corporation's decision of how to best meet its pension obligations and a foundation's decision on how to fund its gifting program.

Traditional investment vehicles such as stocks and bonds are often used to fund such future debts. However, investing in one or the other can have downsides for the debt portfolio. A company, for example, may invest its entire pension-fund assets in zero coupon bonds, which guarantees the ability to meet the company's pension debt. However, investing solely in bonds provides little or no upside potential to the portfolio. If the company invests in stocks or other financial instruments instead of bonds, the volatility of stocks introduces a risk that the pension debt might not be met. Thus, a mix of stocks and bonds (or other assets) may be desired. Without guidance as to the proper mix, however, the portfolio may be exposed to significant risk of loss or little upside potential.

### SUMMARY OF SOME EMBODIMENTS

In various embodiments, a computer-implemented method of creating a financial instrument includes providing a first value representing at least a Standard and Poor's (S&P) 500 total return index, providing a second value representing at least a ten year zero coupon bond price, and creating an asset-liability option having an underlying comprising the ratio index, the asset-liability option including a payoff calculated according to the formula: Payoff=S_{T}−XP_{T}, wherein S_{T} represents a S&P 500 total return index at time T; P_{T} represents the ten year zero coupon bond price at time T; X represents a strike price of the asset-liability option; and wherein Payoff is greater than or equal to zero.

In certain embodiments, a computer-implemented method of comparing financial parameters includes providing a first value representing at least a first financial parameter, providing a second value representing at least a second financial parameter, and calculating in a computer a ratio index comprising a time sequence of the ratio of the first value to the second value.

In addition, in certain embodiments, a computer-implemented method of creating a financial instrument includes providing a first value representing at least a first parameter, providing a second value representing at least a second parameter, calculating in a computer a ratio index comprising a time sequence of the ratio of the first value to the second value, and creating a financial instrument, wherein the price of the financial instrument is based at least in part on the ratio index.

Moreover, in additional embodiments, a computer-implemented method of creating a financial instrument includes providing a first value representing at least a first parameter, providing a second value representing at least a second parameter, calculating in a computer a ratio index comprising a time sequence of the ratio of the first value to the second value, and creating an asset-liability option having an underlying comprising the ratio index.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

Specific embodiments will now be described with reference to the drawings, which are intended to illustrate and not limit the various features of the inventions. Furthermore, a general architecture that implements the various features of the invention will be described with reference to the drawings. In the drawings, similar elements have similar reference numerals.

FIG. 1 illustrates a flowchart diagram depicting an embodiment of a process for creating a ratio index;

FIG. 2 illustrates a flowchart diagram depicting another embodiment of a process for creating a ratio index;

FIG. 3 illustrates a flowchart diagram depicting a process for creating an example ratio index using an S&P 500 Total Return index and a ten year zero coupon bond price;

FIG. 4 illustrates a flowchart diagram depicting a process for creating an example ratio index using an S&P 500 Total Return index and a ten year zero coupon accrual bond index;

FIG. 5 illustrates a histogram depicting example accrual bond index returns, including some statistics;

FIG. 6 illustrates a graph depicting historical performance of an example numerator and denominator of a ratio index;

FIG. 7 illustrates a graph depicting historical performance of an example ratio index;

FIG. 8 illustrates a flowchart diagram depicting an example investment portfolio employing an embodiment of a ratio index;

FIG. 9 illustrates a flowchart diagram depicting another example investment portfolio employing an embodiment of a ratio index;

FIG. 10 illustrates a flowchart diagram depicting yet another example investment portfolio employing an embodiment of a ratio index; and

FIG. 11 illustrates a block diagram of an example computer system in accordance with certain embodiments.

### DETAILED DESCRIPTION OF EMBODIMENTS OF THE INVENTIONS

Several different computer-implemented processes will now be described for calculating and using a ratio index. These processes may be embodied individually or in any combination in a multi-user computer system.

As is described above, one purpose many entities have in holding and investing assets is to pay liabilities. For example, pension funds and insurance companies may hold trillions of dollars in assets in which the primary purpose of the assets is to pay future liabilities. Despite the fact that so many assets are invested to pay liabilities, there are currently no published indices that aim to track the performance of asset portfolios relative to liability portfolios. Such indices, if they existed, could assist individuals and companies in preparing the proper mix of assets to include in their portfolios. Moreover, the ability to purchase financial instruments based on these indices could provide investors with guidance in determining a good mix of investments to meet their future debts.

In certain embodiments, this disclosure describes indices that enable investors to track the relative performance of investing in assets and liabilities. These and other ratio indices can enable investors to better meet their future debts. In addition, various embodiments contemplate creating financial instruments based at least in part on the ratio indices.

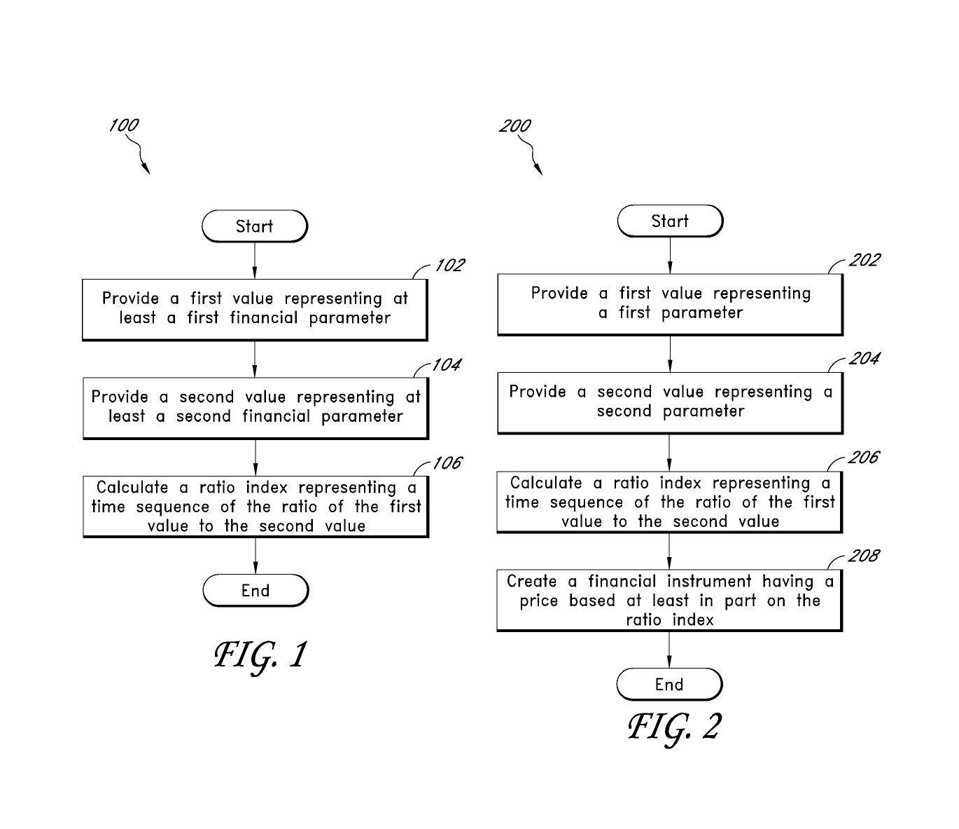

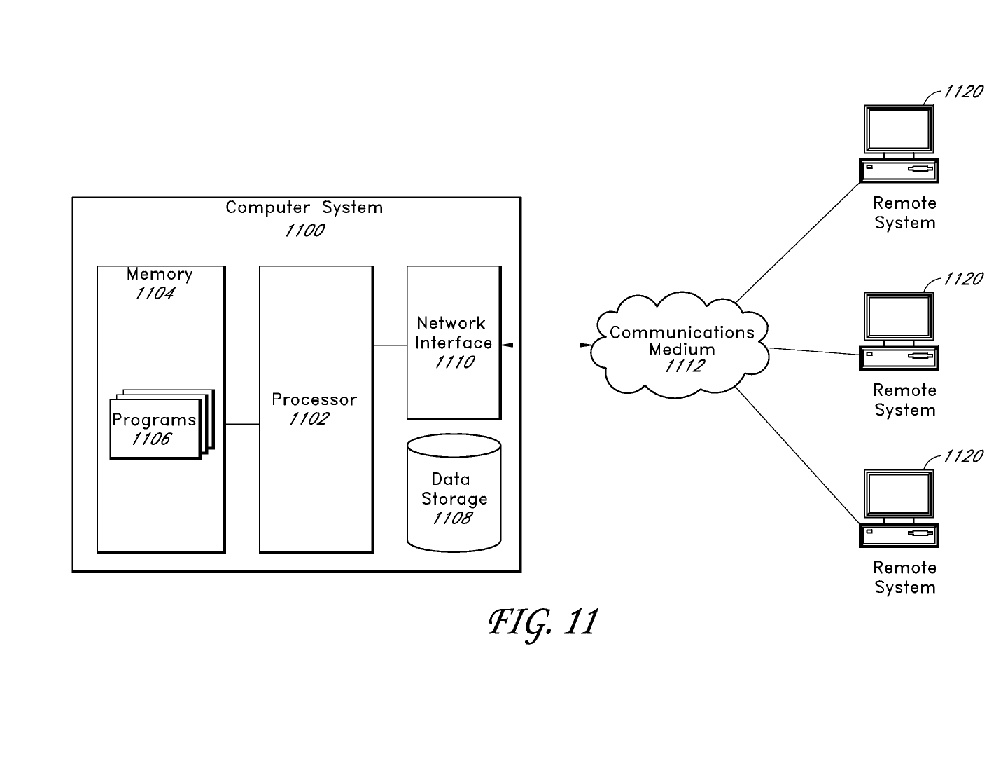

Turning to FIG. 1, a flowchart diagram is illustrated that depicts an embodiment of a process 100 for creating a ratio index. In an embodiment, the process 100 may be implemented by a computer system, such as the computer system described below with respect to FIG. 11. Advantageously, the process 100 of certain embodiments calculates a ratio index that facilitates tracking asset performance relative to liability performance.

Certain embodiments of the process 100 begin at 102 by providing a first value representing at least a first financial parameter. The first financial parameter may be any of a number of securities or other parameters, including but not limited to an index, a stock, a bond price, an exchange rate, or the like. Similarly, at 104, the process 100 provides a second value representing at least a second financial parameter. The second financial parameter may likewise include any of a number of securities or other parameters.

More specific embodiments of the financial parameters can include a ten year bond price, S&P 500 total return index, and hypothetical values (e.g., values not currently existing in the markets) such as 25 years zero coupon bond prices and 50 years copper futures prices. In addition, various other stock and bond indices and/or other financial parameters may be used. For example, the financial parameters may include indices such as the S&P 500 index (non-total return), S&P 500 net return index, S&P 500 futures price, SPDR price, SPDR adjusted price, and other published indices such as DOW, NASDAQ, RUSSEL, DAX, KOSPI, NIKKI, SENSAX, FTSE, MSCI World Index, Nikkei225 total return index, and the like, including proprietary indices. In addition, a single bond or a combination of bonds or bond indexes with accrued coupons (if coupons are issued) can be used, such as a 1 year coupon bond, the average of the 1 year and 5 year bond, and the like.

The first and second values, in one embodiment, each represent one financial parameter. However, in alternative embodiments, these values may each represent multiple financial parameters. In an embodiment, one or both of the first and second values are linear combinations of multiple parameters, such that the parameters are added together and optionally weighted to provide the first or second value (see, e.g., equation (1) below). In another embodiment, one or both of the first and second values include values of financial parameters that are multiplied or divided together. Many other combinations of parameter values are possible.

Referring to step 106, the process 100 calculates a ratio index, which in certain embodiments, represents a time sequence of the ratio of the first value to the second value. In an embodiment, the ratio index is calculated as a quotient of the first value and the second value, such that the first value is the numerator of the ratio index, and the second value is represented as a denominator. However, in certain embodiments the ratio index is calculated in other ways, such as by multiplying by an inverse or the like. In addition, the ratio may be calculated by multiplying vectors or matrices that contain numbers representing the financial parameters and/or inverses of the financial parameters. Moreover, the ratio index can also be represented as a multi-dimensional vector, with a numerator and denominator represented as either scalars or vectors or a combination of parameters and values.

Depending on the nature of the values selected for the numerator and denominator, a variety of ratio indices can be created. These ratio indices can include, for example, the ratio of the Financial Times Stock Exchange (FTSE100) index to spot oil price, the ratio of IBM stock price to USD/GBP exchange rate, the ratio of General Motors' 3 years corporate bond price to 3 month copper futures price, the ratio of the average of the Standard and Poor's (S&P) 500 index and the FTSE100 index to the average of the 10 year bond price and the 5 year bond price, the ratio of two ratio index, and the like.

In an embodiment, the ratio index can be represented by the following:

$$RatioIndex = \frac{{w}_{1} {A}_{1} \pm {w}_{2} {A}_{2} \pm … \pm {w}_{n} {A}_{n}}{{x}_{1} {B}_{1} \pm {x}_{2} {B}_{2} \pm … \pm {x}_{n} {B}_{n}} , \qquad ( 1 )$$

where Aₙ and Bₙ are values of the first and second financial parameters, respectively, and wₙ and xₙ are weights applied to the values of the respective financial parameters. In one embodiment, the terms Aₙ and Bₙ can exist both in the numerator and the denominator. In certain embodiments, the numerator and denominator of equation (1) each represent a linear combination of values or financial parameters. Other combinations of financial parameters are also possible.

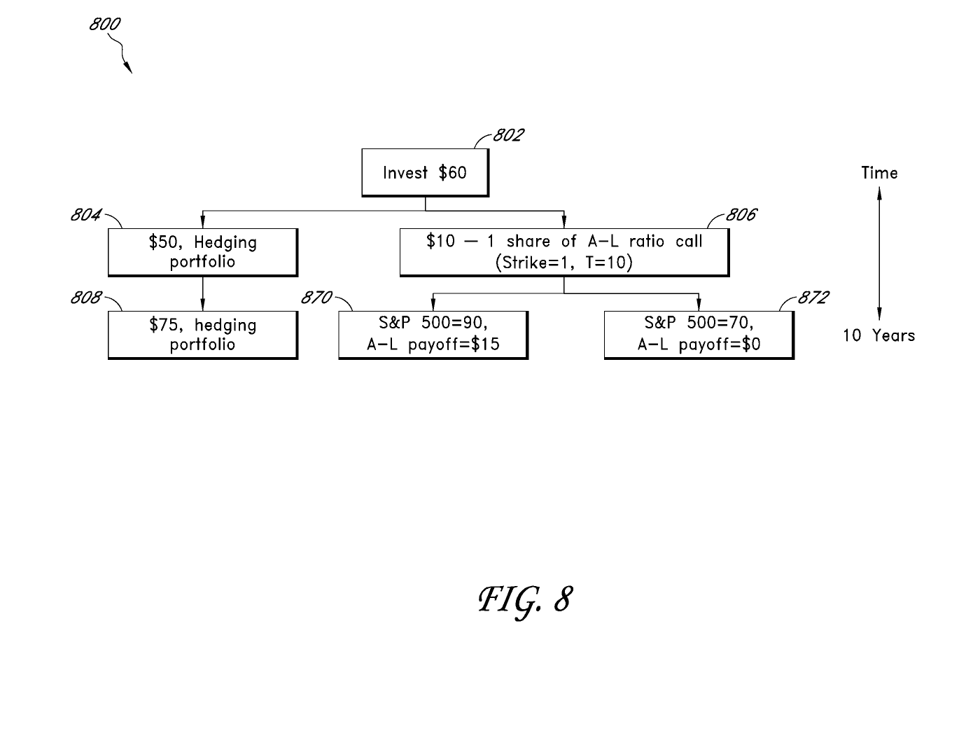

The ratio index can be used broadly in many financial areas. For example, the ratio index can be used for asset allocation purposes (see, e.g., FIGS. 8-10). In an embodiment, the ratio index can also be purchased directly, for example, after a numeraire is defined or selected. The ratio index can also be used for creating financial instruments (see FIG. 2). For example, the ratio index may be used to create and price derivatives such as options.

FIG. 2 illustrates a flowchart diagram that depicts another embodiment of a process 200 for creating a ratio index. Like the process 100, the process 200 may be implemented by a computer system, such as the computer system described below with respect to FIG. 11.

The process 200 begins in various embodiments at 202 by providing a first value representing a first parameter. The first parameter may be a financial parameter or a non-financial parameter. Like the parameters described above with respect to FIG. 1, the parameter can be any of a number of securities or other financial parameters, including but not limited to an index, a stock, a bond price, an exchange rate, or the like. Non-financial parameters in certain embodiments can include general economic indicators (e.g., unemployment rate); weather data; population data, trends, and demographics; society data and trends; crime data and trends; fashion data and trends; geographic data and trends; health data and trends; culture data and trends; environmental data and trends; political data and trends; trade data and trends; immigration, migration, and transportation data and trends; natural and un-natural hazards data and trends; and the like. Similarly, at 204, the process 200 provides a second value representing at least a second parameter, which may also be any financial or non-financial parameter.

The process 200 at 206 calculates a ratio index, which in certain embodiments represents a time sequence of the ratio of the first value to the second value. In an embodiment, this step is performed in the same or a similar way to the step 106 of the process 100 (see FIG. 1). Because the first and second values may represent non-financial parameters, the ratio index of the process 200 may be based on these non-financial parameters. For example, the ratio index may be the ratio of the unemployment rate in the U.S. to the unemployment rate in the U.K. Advantageously, the ratio index can facilitate meaningful interpretation of non-financial parameters such as unemployment rate by tracking the non-financial parameters over time. For example, the ratio index can track unemployment rate in a country as it trends through time and also track how the rate in one country trends relative to another country or to other countries combined.

At 208, the process 200 creates a financial instrument having a price based at least in part on the ratio index. In one embodiment, the financial instrument is a derivative security having one or more ratio indices as an underlying. The derivative may be, for example, any type of option contract, such as a European, American, put, call, collar, straddle, or digital (binary) option. Other possible derivatives can include futures contracts, forward contracts, and swaps. These financial instruments can be purchased or sold by investors to hedge or speculate. The financial instruments can also be contracts between one or more parties and counter-parties, with payouts that can be cash or kind or contracts.

For instance, if an investor decides to invest in treasury bonds but is afraid of losing the opportunity to invest in the equity market, then in one embodiment she can use a portion of the investment to buy a “ratio-call-option” on an equity/bond ratio index as the underlying. If the equity performs better than the bond, she is better off purchasing the ratio-call-option. On the other hand, if an investor decides to invest in equities and is concerned about losing the investment, he can use a portion of the investment to purchase a “ratio-put-option” on an equity/bond ratio index as the underlying to protect/hedge against loss of his investment. In this example embodiment, the ratio-option with the equity/bond ratio index as the underlying can hedge the risk of choosing investment instruments. More detailed examples of using ratio-index based financial instruments to hedge are described with respect to FIGS. 8 through 10 below.

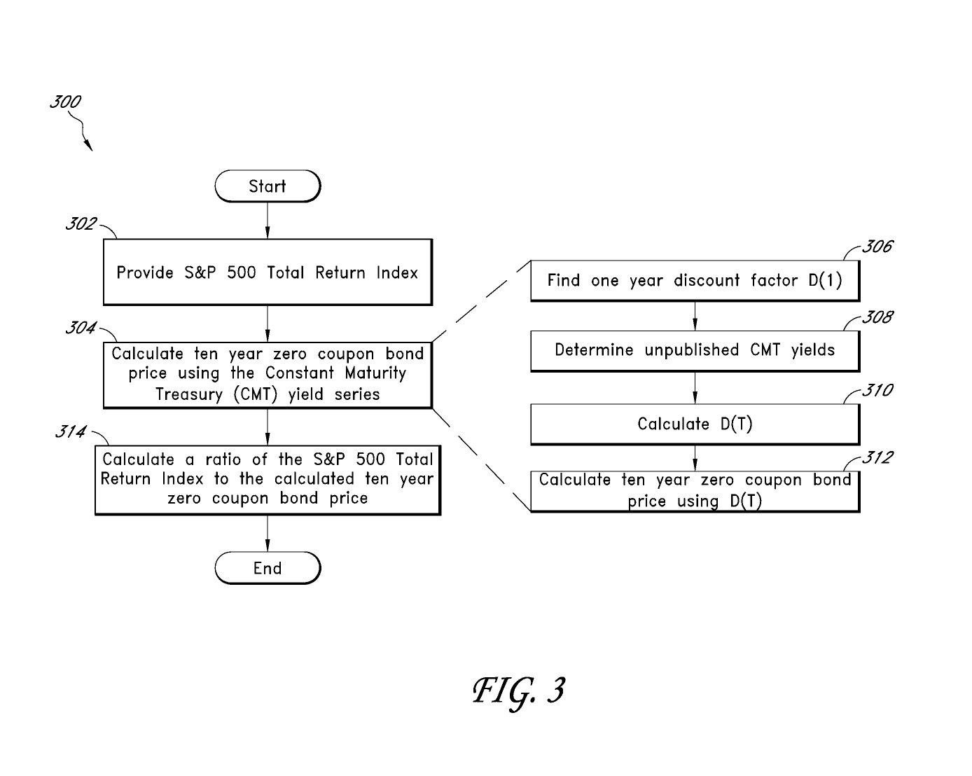

FIG. 3 illustrates a flowchart diagram depicting a process for creating an example ratio index using an S&P 500 total return index and a ten year zero coupon bond. Like the processes described above, the process 300 may be implemented by a computer system, such as the computer system described below with respect to FIG. 11.

The process 300 begins at 302 by providing S&P 500 total return index, an index comprising 500 stocks chosen for market size, liquidity, and industry grouping, among other factors. Because it is a total return index, the index of certain embodiments has dividends and distributions reinvested. In an embodiment, the S&P 500 total return index can be obtained from the Standard and Poor's website using a computer system such as the computer system described below with respect to FIG. 11.

At 304, the process 300 in one embodiment calculates ten year zero coupon bond price using the constant maturity treasury (CMT) yield series. In an embodiment, the calculation of the ten year zero coupon bond price is performed by a bootstrapping procedure incorporating the CMT yield series. The CMT yield series information can be obtained from the Federal Reserve Bank (“Fed”) of St. Louis website, currently http://research.stlouisfed.org, using a computer system such as the computer system described below with respect to FIG. 11. In other embodiments (not shown), inputs other than the CMT rates may be used to calculate the ten year zero coupon bond price.

An example bootstrapping procedure at a high level is as follows; a more detailed example is explained in steps 306 through 312 below. Yields on Treasury nominal securities at “constant maturity” can be interpolated by the U.S. Treasury from the daily yield curve for non-inflation-indexed Treasury securities. This curve, which relates the yield on a security to its time to maturity, can be based on the closing market bid yields on actively traded Treasury securities in the over-the-counter market. These market yields are calculated from composites of quotations obtained by the Federal Reserve Bank of New York. The constant maturity yield values are read from the yield curve at fixed maturities, which may include, for example, 1, 3, and 6 months and 1, 2, 3, 5, 7, 10, 20, and 30 years. This method provides a yield for a 10-year maturity, for example, even if no outstanding security has exactly 10 years remaining to maturity.

The Constant Maturity Treasury (CMT) yield series contain theoretical coupon-bond yields for bonds sold at par. The coupons can be paid every half year. The target of the bootstrapping methodology in certain embodiments is to find the 10 year zero coupon bond price. The CMT series can contain the following yields: 1 month, 3 month, 6 month, 1 year, 2 year, 3 year, 5 year, 7 year, 10 year, 20 year, and 30 year.

Example Bootstrapping Procedure

Turning to a more detailed embodiment, at 306, the process 300 finds the one year discount factor D(1). Table 1 includes hypothetical published CMT yield data that may be obtained from the treasury:

TABLE 1
CMT Yield Data

| | Time to Maturity | | | | | | |
|---|---|---|---|---|---|---|---|
| | 0.5 | 1 | 2 | 3 | 5 | 7 | 10 |
| CMT Yield (%) | 2 | 3 | 4 | 5 | 6 | 7 | 8 |

A discount factor D(T) can be defined as the current (discounted) value of 1 dollar paid at time T. Thus, the zero coupon bond price with time to maturity T is D(T)*$100 (the notional of a zero coupon bond is normally $100).

Since CMT yields are coupon rates for bond sold at par, we have the following formula:

$$1 = {\sum }_{t = 0.5}^{T - 0.5} C \times D ( t ) + D ( T ) \times ( 1 + C ) . \qquad ( 2 )$$

Thus,

$$D ( T ) = \frac{1 - C \times {\sum }_{t = 0.5}^{T - 0.5} D ( t )}{1 + C} , \qquad ( 3 )$$

where C is the coupon rate, which is half of the CMT yield, since coupons are paid every half year in certain embodiments.

Since, in some implementations, coupons are paid every 6 months, the 6 month CMT yield can be the same as the 6 month zero yield. Thus,

$$D ( 0.5 ) = \frac{1}{( 1 + 0.02 / 2 )} = 0.9901 . \qquad ( 4 )$$

To obtain the 1 year discount factor D(1), we have 1=D(0.5)*0.015+D(1)*(1+0.015). Thus, D(1)=0.9706.

At 308, the process 300 determines unpublished CMT yields. Since coupons in certain embodiments are paid every half year, this step can determine D(0.5), D(1), D(1.5), D(2), D(2.5), and so on down to D(9.5) in order to get D(10). However, the treasury in some embodiments does not publish yields such as 1.5 or 2.5 year maturity; hence the process 300 performs an interpolation. There are many interpolation methods available, among which linear interpolation, polynomial interpolation, and spline-curve interpolation can be used. In an embodiment, linear interpolation techniques are used to find the unpublished yields (see equation (5)). For details of other interpolation techniques, please refer to Kincaid, D. & Ward C. (2002), Numerical Analysis (3rd edition), Brooks/Cole, ISBN 0534389058, Chapter 6; and Schatzman, Michelle (2002), Numerical Analysis: A Mathematical Introduction, Clarendon Press, Oxford, ISBN 0198502796, Chapters 4 and 6, both of which are hereby incorporated by reference in their entirety.

$${C}_{t} = {C}_{a} + \frac{( t - a ) ( {C}_{b} - {C}_{a} )}{( b - a )} \qquad ( 5 )$$

where Cₜ is the unknown CMT yield with time to maturity t, a and b are the time to maturities nearest to t with known CMT yields Cₐ and C_{b}.

By using Equation (5), the CMT yields can be obtained, as shown in Table 2.

TABLE 2
CMT Yields

| Time to Maturity | |
|---|---|
| (year) | Yield |
| 0.5 | 2 |
| 1 | 3 |
| 1.5 | 3.5 |
| 2 | 4 |
| 2.5 | 4.5 |
| 3 | 5 |
| 3.5 | 5.25 |
| 4 | 5.5 |
| 4.5 | 5.75 |
| 5 | 6 |
| 5.5 | 6.25 |
| 6 | 6.5 |
| 6.5 | 6.75 |
| 7 | 7 |
| 7.5 | 7.166667 |
| 8 | 7.333333 |
| 8.5 | 7.5 |
| 9 | 7.666667 |
| 9.5 | 7.833333 |
| 10 | 8 |

At 310, the process 300 calculates D(T). By utilizing the same procedure of step 306, the process 300 can calculate D(1.5) from D(0.5) and D(1), can calculate D(2) from D(0.5), D(1) and D(1.5), and so on until the unpublished yield data is calculated. A set of example ten year data is shown in Table 3.

TABLE 3
Ten Year Data - D(T)

| T | D(T) |
|---|---|
| (time to Maturity) | (the zero bond price) |
| 0.5 | 0.9901 |
| 1 | 0.9706 |
| 1.5 | 0.9491 |
| 2 | 0.9233 |
| 2.5 | 0.8936 |
| 3 | 0.8603 |
| 3.5 | 0.8315 |
| 4 | 0.8014 |
| 4.5 | 0.7703 |
| 5 | 0.7381 |
| 5.5 | 0.7052 |
| 6 | 0.6716 |
| 6.5 | 0.6374 |
| 7 | 0.6029 |
| 7.5 | 0.5729 |
| 8 | 0.5431 |
| 8.5 | 0.5134 |
| 9 | 0.4841 |
| 9.5 | 0.455 |
| 10 | 0.4264 |

At 312, the process 300 calculates the ten year zero coupon bond price. In the above example, the ten year zero coupon bond price is 0.4264*$100=$42.64.

Note that using the D(T) values from Table 3, the zero coupon bond prices for maturity 6 months to 10 years can be calculated. For calculating the zero coupon bond prices for maturity longer than 10 years, the bootstrap technique described above can be used to calculated the unpublished yields every six months while making use of the published yield data beyond 10 years and calculating the D(T) for beyond 10 years.

Example RST Ratio Index

Referring again to FIG. 3, the process at 314 calculates a ratio of the S&P 500 total return index to the calculated ten year zero coupon bond price. In one embodiment, this ratio index is referred to as the RST Index. The RST Index may be used to track the relative performance portfolios and create financial instruments, such as those described above with respect to FIG. 2.

Stochastic models facilitate analysis of several properties of ratio indices based on the S&P 500 total return index and ten year zero coupon bond price. However, different models of the S&500 total return index and the ten year zero coupon bond price can yield different stochastic behavior of the ratio index. To illustrate some basic properties of the ratio index using these parameters, the following stochastic models use example “parsimonious” models to describe the S&P total return index and the ten year zero coupon bond prices. Example financial instruments using these stochastic models are described below. Other models may also be used to analyze the behavior of the RST Index in other embodiments.

The S&P 500 total return index can be described as a Geometric Brownian Motion (GBM). In the risk neutral measure, the drift of the index is the risk free rate rₜ, thus

$$\frac{ⅆ {S}_{t}}{{S}_{t}} = {r}_{t} ⅆ t + {σ}_{s} ⅆ {W}_{s} \\ or \\ ⅆ ( ln {S}_{t} ) = ( {r}_{t} - \frac{1}{2} {σ}_{s}^{2} ) ⅆ t + {σ}_{s} ⅆ {W}_{s} . \qquad ( 6 )$$

In the physical measure,

$$\frac{ⅆ {S}_{t}}{{S}_{t}} = ( {r}_{t} + λ ) ⅆ t + {σ}_{s} ⅆ {W}_{s} \\ or \\ ⅆ ( ln {S}_{t} ) = ( {r}_{t} + λ - \frac{1}{2} {σ}_{s}^{2} ) ⅆ t + {σ}_{s} ⅆ {W}_{s} , \qquad ( 7 )$$

where Sₜ is the S&P 500 total return index at time t, λ is the risk premium, σₛ is its volatility, and Wₛ is a wiener process.

The ten year zero coupon bond price (Pₜ) can depend on short term interest rates because the CMT yields can depend on these rates. Thus,

$${P}_{t} = A \times {E}_{t}^{\underline{O}} [ exp ( - {\int }_{t}^{t + τ} {r}_{u} ⅆ u ) ] , \qquad ( 8 )$$

where A is the notional ($100 in our case), t is the current physical time, τ is the time to maturity (10 years in our case), rᵤ is the short interest rate in risk neutral measure, and Eₜ^{Q} denotes the expectation under the risk neutral measure Q conditional on the information at time t. There are many models to model the short interest rate, including the single factor model, (see, e.g., Cox, C., J. Ingersoll and S. Ross (1985): “An intertemporal general equilibrium models of asset prices,” Econometrica, 53 363-384, which is hereby incorporated by reference in its entirety) and multifactor model (see, e.g., Dai, Q. and K. Singleton (2000): “Specification analysis of affine term structure models”, Journal of Finance 55, 1943-1978, which is hereby incorporated by reference in its entirety). In one embodiment, a Vasicek model (see Vasicek, O. (1977): “An Equilibrium Characterization of the Term Structure”, Journal of Financial Economics, 5: 177-188, which is hereby incorporated by reference in its entirety) can be used to model the short interest rate in the physical measure (Equation (9)) and the risk neutral measure (Equation (10)):
drₜ=k(φ−rₜ)dt+σᵣdWᵣ (9)
drₜ=k(θ−rₜ)dt+σᵣdWᵣ, (10)
where k is the mean reverting speed of the short interest rate, θ is the long-run mean, σᵣ is its volatility, and Wᵣ is a Wiener process of the short interest rate with correlation ρ to the Wₛ process. The expression k(φ−θ) can be seen as a constant risk premium. The short rate process can be calibrated using the CMT yields provided by the Fed.

By solving equation (8) and (10), we can get the bond price Pₜ at time t,

$${P}_{t} = A \times exp [ - {Cr}_{t} + D ] \\ C = \frac{1 - exp ( - k τ )}{k} \\ D = ( θ - \frac{{σ}_{r}^{2}}{2 {k}^{2}} ) [ C - τ ] - \frac{{σ}_{r}^{2} {C}^{2}}{4 k} . \qquad ( 11 )$$

Note that both C and D are constants.

Thus, in risk neutral measure:
d(ln Pₜ)=Ck(rₜ−θ)dt−CσᵣdWᵣ. (12)
Equation (13) is obtained by using Equation (6) minus Equation (12):

$$ⅆ ( ln ( \frac{{S}_{t}}{{P}_{t}} ) ) = [ ( 1 - Ck ) {r}_{t} + Ck θ - \frac{1}{2} {σ}_{s}^{2} ] ⅆ t + {σ}_{s} ⅆ {W}_{s} + C {σ}_{r} ⅆ {W}_{r} . \qquad ( 13 )$$

Thus, given the information at time zero (say, the price of S₀ and P₀), the ratio of S to P at time T, Z_{T}, can be written as:

$$\begin{matrix}ln ( {Z}_{T} ) = ln ( \frac{{S}_{T}}{{P}_{T}} ) \\ = ln ( \frac{{S}_{0}}{{P}_{0}} ) + ( Ck θ - \frac{1}{2} {σ}_{s}^{2} ) T + \\ ( 1 - Ck ) {\int }_{0}^{T} {r}_{t} ⅆ t + {σ}_{s} {\int }_{0}^{T} ⅆ {W}_{s} + C {σ}_{r} {\int }_{0}^{T} ⅆ {W}_{{r}^{′}}\end{matrix} \qquad ( 14 )$$

since

$${r}_{t} = {r}_{0} {ⅇ}^{- kt} + θ ( 1 - {ⅇ}^{- kt} ) + {ⅇ}^{- kt} {σ}_{r} {\int }_{0}^{t} {ⅇ}^{ku} ⅆ {W}_{u} .$$

After changing integration order, Equation (14) can be rewritten as:

$$\begin{matrix}ln ( {Z}_{T} ) = ln ( \frac{{S}_{T}}{{P}_{T}} ) \\ = ln ( \frac{{S}_{0}}{{P}_{0}} ) + ( Ck θ - \frac{1}{2} {σ}_{s}^{2} ) T + ( 1 - Ck ) \\ [ {r}_{0} \frac{1 - {ⅇ}^{- kT}}{k} + θ ( T - \frac{1 - {ⅇ}^{- kT}}{k} ) ] + \\ ( 1 - Ck ) {σ}_{r} {\int }_{0}^{T} \frac{1 - {ⅇ}^{- k ( T - t )}}{k} ⅆ {W}_{r} + \\ {σ}_{s} {\int }_{0}^{T} ⅆ {W}_{s} + C {σ}_{r} {\int }_{0}^{T} ⅆ {W}_{r} .\end{matrix} \qquad ( 15 )$$

After collecting items in Equation (15), we have:

$$ln ( \frac{{S}_{T}}{{P}_{T}} ) = ln ( \frac{{S}_{0}}{{P}_{0}} ) + ( Ck θ - \frac{1}{2} {σ}_{s}^{2} ) T + ( 1 - Ck ) [ {r}_{0} \frac{1 - {ⅇ}^{- kT}}{k} + θ ( T - \frac{1 - {ⅇ}^{- kT}}{k} ) ] + {σ}_{r} {\int }_{0}^{T} \frac{1 - {ⅇ}^{- k ( T - t )} + Ck {ⅇ}^{- k ( T - t )}}{k} ⅆ {W}_{r} + {σ}_{s} {\int }_{0}^{T} ⅆ {W}_{s} . \qquad ( 16 )$$

Equation (16) can be rewritten as

$${Z}_{T} = \frac{{S}_{T}}{{P}_{T}} = exp [ \begin{matrix}ln ( \frac{{S}_{0}}{{P}_{0}} ) + ( Ck θ - \frac{1}{2} {σ}_{s}^{2} ) T + ( 1 - Ck ) \\ [ {r}_{0} \frac{1 - {ⅇ}^{- kT}}{k} + θ ( T - \frac{1 - {ⅇ}^{- kT}}{k} ) ] + \\ {σ}_{r} {\int }_{0}^{T} \frac{1 - {ⅇ}^{- k ( T - t )} + Ck {ⅇ}^{- k ( T - t )}}{k} ⅆ {W}_{r} + \\ {σ}_{s} {\int }_{0}^{T} ⅆ {W}_{s}\end{matrix} ] . \qquad ( 17 )$$

From Equation (16), we can see that the log of the example ratio index can follow a normal distribution with mean M_{Z} and standard deviation V_{Z}:

$$\begin{matrix}{M}_{Z} = ln ( \frac{{S}_{0}}{{P}_{0}} ) + ( Ck θ - \frac{1}{2} {σ}_{s}^{2} ) T + ( 1 - Ck ) [ {r}_{0} \frac{1 - {ⅇ}^{- kT}}{k} + θ ( T - \frac{1 - {ⅇ}^{- kT}}{k} ) ] & ( 18 ) \\ {η}_{r}^{T} = \frac{{σ}_{r}}{k} \sqrt{T + \frac{2 ( Ck - 1 )}{k} ( 1 - {ⅇ}^{- kT} ) + \frac{{( Ck - 1 )}^{2}}{2 k} ( 1 - {ⅇ}^{- 2 kT} )} \\ {η}_{s}^{T} = {σ}_{s} \sqrt{T} \\ {V}_{Z} = \sqrt{{η}_{s}^{2} + {η}_{r}^{2} + 2 ρ {η}_{r} {η}_{s}} . & ( 19 )\end{matrix}$$

where ρ is the correlation between the Wᵣ and Wₛ. Thus, the example ratio index of certain embodiments follows a log normal distribution. Thus, Z_{T} can be written as

$${Z}_{T} = exp ( {M}_{Z} + ( {η}_{r}^{T} + {η}_{s}^{T} ρ ) {R}_{1} + {η}_{s}^{T} \sqrt{1 - {ρ}^{2}} {R}_{2} ) , \qquad ( 20 )$$

where R₁ and R₂ are independent random numbers following standard normal distributions (mean zero and standard deviation one).

Note that Equation (16) is in the risk neutral measure. In the physical measure, we can get very similar results:

$$ln ( \frac{{S}_{T}}{{P}_{T}} ) = ln ( \frac{{S}_{0}}{{P}_{0}} ) + ( Ck ϕ + λ \frac{1}{2} {σ}_{s}^{2} ) T + ( 1 - Ck ) [ {r}_{0} \frac{1 - {ⅇ}^{- kT}}{k} + ϕ ( T - \frac{1 - {ⅇ}^{- kT}}{k} ) ] + {σ}_{r} {\int }_{0}^{T} \frac{1 - {ⅇ}^{- k ( T - t )} + Ck {ⅇ}^{- k ( T - t )}}{k} ⅆ {W}_{r} + {σ}_{s} {\int }_{0}^{T} ⅆ {W}_{s} . \qquad ( 21 )$$

The stochastic models described above may be calibrated to obtain various model parameters useful for creating and pricing financial instruments such as derivatives. In one embodiment, the volatility of the S&P 500 total return index is determined in the risk neutral measure. The volatility can be calculated using the daily return standard deviation multiplied by the number of annual business days.

Regarding interest rates, the Chen, Scott method (see Chen, R. and L. Scott (1993), Maximum Likelihood Estimation for a Multifactor Equilibrium Model of the Term Structure of Interest Rates, The Journal of Fixed Income, 14-31, which is hereby incorporated by reference in its entirety) is a commonly used method to calibrate the interest rate term structure model. Since the short interest rates are not observed directly in some example data sets, the Chen and Scott approach directly pin down the latent state variables by arbitrarily inverting several securities, which are assumed to be priced without error in the market. The remaining securities are assumed to be priced with measurement errors.

Five zero coupon bond prices are first obtained using the bootstrapping method (described above). Let P(T₁) to P(T₅) represent the 5 zero coupon bond prices (with maturity T₁ to T₅). Suppose the first bond price is correctly measured without measurement error, other securities, P(T₂) to P(T₅), are priced with errors. Thus, the model estimation equations are shown as follows:
ln(P(T₁))=ln(A)−C₁rₜ+D₁
ln(P(T₂))=ln(A)−C₂rₜ+D₂+u₂ₜ
ln(P(T₃))=ln(A)−C₃rₜ+D₃+u₃ₜ,
ln(P(T₄))=ln(A)−C₄rₜ+D₄+u₄ₜ
ln(P(T₅))=ln(A)−C₅rₜ+D₅+u₅ₜ (22)
where Cᵢ and Dₜ are defined in Equation (11), u₂ₜ to u₅ₜ are measurement errors which are assumed to have a joint normal distribution. The log-likelihood function for bond prices at time t is:
Lₜ=−ln C₁+ln Lₜ^{s}+ln Lₜ^{e}, (23)
where ln Lₜ^{s} is the log likelihood of the latent short interest rate rₜ at time t, ln Lₜ^{e} is the log likelihood of the other bonds P(t,T₂) to P(t,T₅). Further,

$$ln ( {L}_{t}^{s} ) = - \frac{1}{2} ln ( 2 π ) - \frac{1}{2} ln ( {V}_{r} ) - \frac{1}{2} \frac{{( {r}_{t} - {r}_{m} )}^{2}}{{V}_{r}} \\ {V}_{r} = \frac{1 - {ⅇ}^{- 2 k Δ t}}{2 k} {σ}_{r}^{2} \\ {r}_{m} = {r}_{t - 1} {ⅇ}^{- k Δ t} + ϕ ( 1 - {ⅇ}^{- k Δ t} ) \\ {L}_{t}^{e} = - \frac{1}{2} ln ( 2 π ) - \frac{1}{2} ln ( \vert Ω \vert ) - \frac{1}{2} {u}_{t}^{′} {Ω}^{- 1} {u}_{t} . \qquad ( 24 )$$

In equation (23), −C₁ is actually the coefficient in the linear transformation from rₜ to P(t,Tᵢ), and thus, the Jacobian of the transformation is 1/|C₁|. Since the first bond is priced without error, its log-likelihood is determined by the log-likelihood of state variable (short interest rate) ln Lₜ^{s}, adjusted by the Jacobian multiplier (1/|C₁|). Vᵣ is the variance of the short interest rate conditional on rₜ₋₁; rₘ is the mean of rₜ conditional on rₜ₋₁; Δt is the time interval of the observations; uₜ is a column vector (u₂, u₃, u₄, u₅)′; and Ω is the covariance matrix of uₜ. The total log likelihood

$${\sum }_{t} {L}_{t}$$

in certain embodiments can be maximized, substantially maximized, or otherwise increased in order to obtain the model parameters.

After the latent short interest rate rₜs is determined, the randomness Wᵣs can be obtained. Thus, the correlation between Wᵣ and Wₛ can be calculated.

Various properties of the RST Index are advantageous for investors. For example, it can be easy to design derivatives (such as options, futures) on the RST index. The fluctuation of the RST index can represent the relative performance of the numerator and the denominator. Thus, by long or short, investors using the RST index (or its derivatives) can hedge their risk of choosing wrong investment instruments. In addition, in an embodiment, the RST Index has no maturity. Since the denominator of certain embodiments is a constant time to maturity security price (and not fixed maturity price), the RST Index does not have a fixed maturity. This property can also offer a relatively stable volatility of the RST index. Moreover, since both the numerator and the denominator of the RST Index do not shed dividends in certain embodiments, the RST index can represent the actual or real (including dividends) relative performance of investing in different securities. Other numerators such as the S&P 500 index do not achieve this property. Also, the RST Index can allow investors to easily hedge the RST Index and its derivatives by utilizing SPDR or S&P 500 index futures and treasury bonds.

Example Financial Instruments Based on the RST Index

Several financial instruments, including derivatives, can be created using the RST Index. Three such example instruments described in further detail herein include European options, binary options, and asset-liability options.

For European options, a call option can be priced with price c as:
c=E^{Q}[D×max(Z_{T}−X,0)]=E^{Q}[max(D·Z_{T}−D·X,0)] (25)
where Q stands for risk neutral measure, D (different from the D in equation (11)) is the discount factor, and X is the strike price. Z_{T} is provided, for example, in Equations (16) and (24) above, and D is shown as follows (in Equation (26)).
D=exp(−M_{D}−η_{D}^{T}R₁) (26)
where

$$\begin{matrix}{M}_{D} = {r}_{0} \frac{1 - {ⅇ}^{- kT}}{k} + θ ( T - \frac{1 - {ⅇ}^{- kT}}{k} ) \\ and & ( 27 ) \\ {η}_{D}^{T} = \frac{{σ}_{r}}{k} \sqrt{T - \frac{2}{k} ( 1 - {ⅇ}^{- kT} ) + \frac{1}{2 k} ( 1 - {ⅇ}^{- 2 kT} )} . & ( 28 )\end{matrix}$$

Thus, in one embodiment, the call option price c is:

$$c = {E}^{Q} [ max \{ exp ( {M}_{Z} - {M}_{D} + ( {η}_{r}^{T} + {η}_{s}^{T} ρ - {η}_{D}^{T} ) {R}_{1} + {η}_{s}^{T} \sqrt{1 - {ρ}^{2}} {R}_{2} ) - X exp ( - {M}_{D} - {η}_{D}^{T} {R}_{1} ) , 0 \} ] \qquad ( 29 )$$

The expectation in Equation (29) can be rewritten by integration.

$$c = {\int }_{- ∞}^{∞} {\int }_{- ∞}^{∞} max \{ exp ( {M}_{Z} - {M}_{D} + ( {η}_{r}^{T} + {η}_{s}^{T} ρ - {η}_{D}^{T} ) {x}_{1} + {η}_{s}^{T} \sqrt{1 - {ρ}^{2}} {x}_{2} ) - X exp ( - {M}_{D} - {η}_{D}^{T} {x}_{1} ) , 0 \} \times \frac{1}{2 π} exp ( - \frac{{x}_{1}^{2}}{2} - \frac{{x}_{2}^{2}}{2} ) ⅆ {x}_{1} {x}_{2} \qquad ( 30 )$$

where x₁ and x₂ are the realization of the random variable R₁ and R₂. Although the theoretical upper limit and lower limit in the integral are infinity, the appropriate area for both x₁ and x₂ can be from −5 to 5 since the normal random variable of certain embodiments rarely exceeds 5 times its standard deviation.

From Equation (30), the European call, c, can be priced by numerical integration method such as Gaussian Quadrature methods or the fast Fourier transform (see Press, W., S. Teukolsky, W. Vetterling, B. Flannery (2002): “Numerical Recipes in C++: The art of scientific computing”, Cambridge University Press, ISBN 0521750334, which is hereby incorporated by reference in its entirety). Both methods can be very fast (less than 0.5 second).

Using the European call option, a put option can also be priced by put-call parity.
c−p=Z₀−B₀X (31)
where p is the value of a put option, B₀ is the zero coupon bond price with maturity T.

Examples are provided in order to illustrate the option pricing formulas. Table 4 shows the hypothetical parameter values in Equations (16) through (30). Table 5 shows example European put and call option prices for various strike prices X.

TABLE 4
Example Parameter Values

| k | r₀ | σₛ | σᵣ | θ | S₀ | P₀ | T (years) | P |
|---|---|---|---|---|---|---|---|---|
| 0.1 | 2% | 18% | 2% | 4% | 1000 | 70 | 10 | 0 |

Z₀ = S₀/P₀ = 14.3

TABLE 5
European Option Prices

| | Strike Price, X | | | |
|---|---|---|---|---|
| | 22 | 18 | 14 | 10 |
| Call Option Price | 4.1641 | 5.2965 | 6.7939 | 8.7659 |
| Put Option Price | 5.278386 | 3.610786 | 2.308186 | 1.480186 |

As described above, the stochastic models of the RST Index may also be used to create digital (or binary) options. A digital call option can be defined as follows: if the underlying price is higher than the strike price at maturity T, then the owner of the option will obtain one unit of money at maturity. That is:
b=1_{{Z(T)>X}} (32)
where b is the binary call price. Thus, the binary call price can be written as:

$$b = {\int }_{- ∞}^{∞} {\int }_{- ∞}^{∞} {1}_{\{ exp ( {M}_{Z} + ( {η}_{r}^{T} + {η}_{s}^{T} ρ ) {x}_{1} + {η}_{s}^{T} \sqrt{1 - {ρ}^{2}} {x}_{2} ) > X \}} \times exp ( - {M}_{D} - {η}_{D}^{T} {x}_{1} ) \times \frac{1}{2 π} exp ( - \frac{{x}_{1}^{2}}{2} - \frac{{x}_{2}^{2}}{2} ) ⅆ {x}_{1} {x}_{2} \qquad ( 33 )$$

An example binary put price, w, is

$$b = {\int }_{- ∞}^{∞} {\int }_{- ∞}^{∞} {1}_{\{ exp ( {M}_{Z} + ( {η}_{r}^{T} + {η}_{s}^{T} ρ ) {x}_{1} + {η}_{s}^{T} \sqrt{1 - {ρ}^{2}} {x}_{2} ) < X \}} \times exp ( - {M}_{D} - {η}_{D}^{T} {x}_{1} ) \times \frac{1}{2 π} exp ( - \frac{{x}_{1}^{2}}{2} - \frac{{x}_{2}^{2}}{2} ) ⅆ {x}_{1} {x}_{2} \qquad ( 34 )$$

Table 6 illustrates example binary call and put prices for various strike prices X.

TABLE 6
Binary Option Prices

Strike Price, X

| | 22 | 18 | 14 | 10 |
|---|---|---|---|---|
| Binary Call Price | 0.2457 | 0.3244 | 0.4290 | 0.5611 |
| Binary Put Price | 0.5410 | 0.4623 | 0.3577 | 0.2255 |

As described above, the stochastic models of the RST Index may also be used to create asset-liability options. The payoff of an example asset-liability call option can be defined as:

$$Payoff = {P}_{T} max ( \frac{{S}_{T}}{{P}_{T}} - X , 0 ) \qquad ( 35 )$$

where S_{T} is the total return index, P_{T} is the ten year coupon bond prices at time T, X is the strike price. That is to say, when the option is in the money, the option owners, instead of receiving

$$\frac{{S}_{T}}{{P}_{T}} - X$$

dollars, get

$$\frac{{S}_{T}}{{P}_{T}} - X$$

shares of ten year zero coupon bond, or the equivalent amount of dollars

$$( \frac{{S}_{T}}{{P}_{T}} - X ) {P}_{T} .$$

In certain embodiments, the payoff is greater than or equal to zero.

Equation (35) can be re-written as:
Payoff=max(S_{T}−XP_{T},0) (36)
Thus, this asset-liability option can be seen as a call option on the spread of S_{T} and X shares of P_{T}. P_{T} can be expressed as
P_{T}=A×exp[−C(M_{D}+η_{D}^{T}R₁)+D], (37)
where C and D are defined in Equation (11). Using the stochastic models described above, an example asset-liability call option price, g is:

$$g = {\int }_{- ∞}^{∞} {\int }_{- ∞}^{∞} max \{ exp ( {M}_{Z} - {M}_{D} + ( {η}_{r}^{T} + {η}_{s}^{T} ρ - {η}_{D}^{T} ) {x}_{1} + {η}_{s}^{T} \sqrt{1 - {ρ}^{2}} {x}_{2} ) - X exp ( - {M}_{D} - {η}_{D}^{T} {x}_{1} ) , 0 \} \times A \times exp [ - C ( {M}_{D} + {η}_{D}^{T} {x}_{1} ) + D ] \times \frac{1}{2 π} exp ( - \frac{{x}_{1}^{2}}{2} - \frac{{x}_{2}^{2}}{2} ) ⅆ {x}_{1} {x}_{2} . \qquad ( 38 )$$

For other complicated derivatives such as Asian options, many simulation techniques such as Monte Carlo simulation can be used to calculate the correct price. For details of the general Monte Carlo simulation technique, please refer to Tavella, D. (2002), Quantitative Methods in Derivatives Pricing: An Introduction to Computational Finance, Wiley press, ISBN 0471394475, which is hereby incorporated by reference in its entirety. The American options on the RST index can be determined using least square Monte Carlo methods (see Longstaff, F and E Schwartz (2001): “Valuing American options by simulation: A simple least-square approach”, Review of Financial Studies, 14, 113-147, which is hereby incorporated by reference in its entirety).

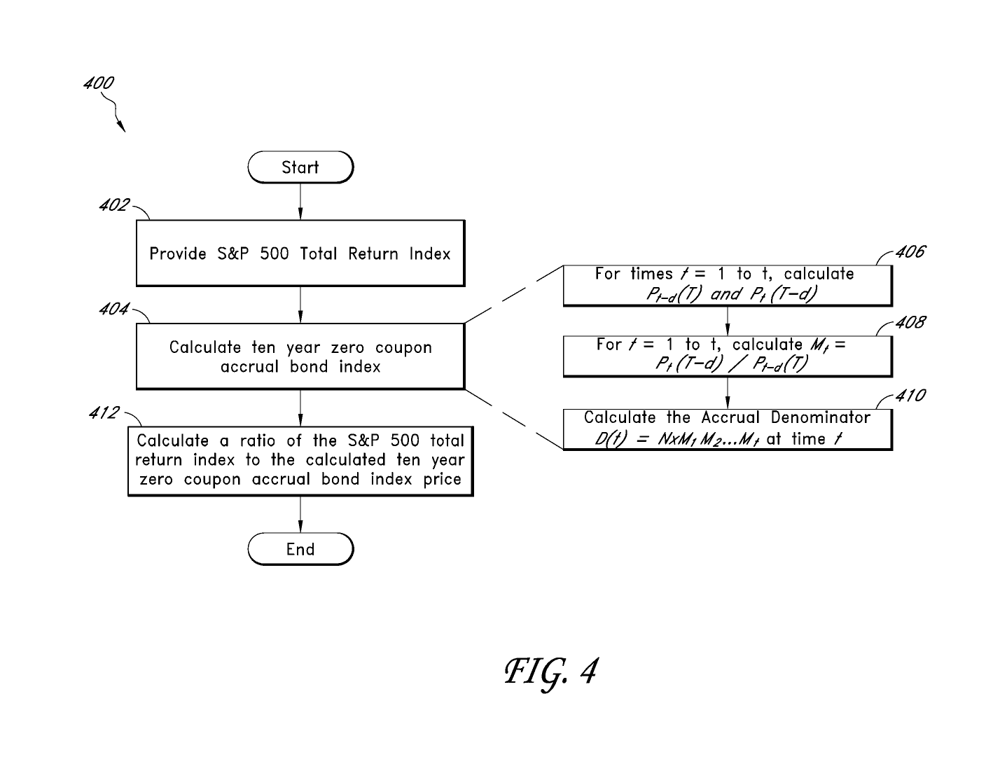

FIG. 4 illustrates a flowchart diagram depicting a process for creating an example ratio index using an S&P 500 Total Return index and a ten year zero coupon accrual bond index. Like the processes described above, the process 400 may be implemented by a computer system, such as the computer system described below with respect to FIG. 11.

The process 400 at 402 begins by providing an S&P 500 total return index, such as the S&P 500 total return index described above with respect to FIG. 3. At 404, the process 400 calculates ten year zero coupon accrual bond index. In an embodiment, the ten-year, zero-coupon accrual bond index uses the ten-year, zero-coupon bond described above to develop the accrual bond index. The ten-year, zero-coupon bond price can be calculated in certain embodiments from the whole series of Constant Maturity Treasury (CMT) rates using the bootstrapping procedure described above.

Example Accrual Bond Index

An accrual bond index, also referred to as an accrual denominator D(t), can be developed using steps 406 through 412 of the process 400. In an embodiment, let t denote zero coupon bond price update time, d denote update interval, τ denote the time to maturity, and CMT(t) denote the whole series of constant maturity rates published by the Federal Reserve Bank at time t.

At 406, the process 400 calculates, for times t=1 to t, P_{t-d}(τ) and Pₜ(τ−d), where Pₜ(τ−d) is the price of a zero coupon bond at time t with time to maturity τ−d, calculated from the term structure of interest rates developed by the bootstrapping procedure using CMT rates at time t, e.g., CMT(t) rates. P_{t-d}(τ) is the price of a zero coupon bond at time t−d with time to maturity τ, calculated from the term structure of interest rates developed by the bootstrapping procedure using CMT rates at time t−d, e.g., CMT(t−d) rates. For ten-year, zero-coupon bonds with an example update period of one week, τ=10 years and d=1 week.

At 408, the process 400 calculates, for t=1 to t, Mₜ=Pₜ(τ−d)/P_{t-d}(τ), where Mₜ represents the proceeds (capital gain) at time t from investing $1 in τ time to maturity zero coupon bonds at time t−d for a period d.

At 410, the process 400 calculates the accrual denominator D(t) at time t,
D(t)=N×M₁M₂ . . . Mₜ, (39)
where N is a constant used to adjust D(t) to a suitable number. For example, if the numerator of the ratio index is 100 and the denominator was 20 at the inception of the index, then N could be set to 5 so that the ratio index starts at one.

The accrual denominator D(t) provides a backward looking total return measure of continual investment in bonds of a fixed time to maturity. The accrual denominator for coupon bonds can also be built following the above procedure, but in addition to capital gain, consideration can also be given to the accrual of the coupon payments to get the total return.

In an embodiment, the ten-year, zero-coupon accrual bond index (where τ=10 years and d=1 week) represents the amount of proceeds (capital gain) an investor would have at time t from investing $1 at time 0 in ten-year, zero-coupon bonds and continually “rolling over” the investment on a regular basis. “Rolling over” can be illustrated with the following example. On 1 Jan. 2007, an investor invests $1 in a ten-year, zero-coupon bond. This bond matures on 1 Jan. 2017. After one week, i.e., 8 Jan. 2007, the investor sells this bond and reinvests the proceeds from this sale in another ten-year, zero-coupon bond, which matures on 8 Jan. 2017. After another week, i.e., 15 Jan. 2007, the investor sells this bond and reinvests the proceeds in a new ten-year, zero-coupon bond, which matures on 15 Jan. 2017. This process may be repeated as desired.

The amount of money currently invested at time t is the accrual denominator D(t). In the example “rolling” strategy outlined above, the accrual denominator has a fixed maturity of ten years. The “rolling over” frequency or update frequency is not limited to once per week but can be any suitable time. The update frequency for the numerator (of the alternative ratio index discussed below) can be the same as the denominator update frequency, or it can be different. In the description below, we assume the accrual denominator is updated once per week, which is the same as the update frequency of the CMT rates.

Example Alternative Ratio Index

Referring again to FIG. 4, the process at 412 calculates a ratio of the S&P 500 total return index to the calculated ten year zero coupon accrual bond index. In one embodiment, this ratio index can be referred to as the Alternative Ratio Index. Like the RST Index, the Alternative Ratio Index may be used for several purposes, including hedging, speculating, creating financial instruments, and the like.

To illustrate some basic properties of the Alternative Ratio Index, the following stochastic models use ‘parsimonious’ models to describe the S&P total return index and the ten year zero coupon bond prices. Example financial instruments using these stochastic models are described below.

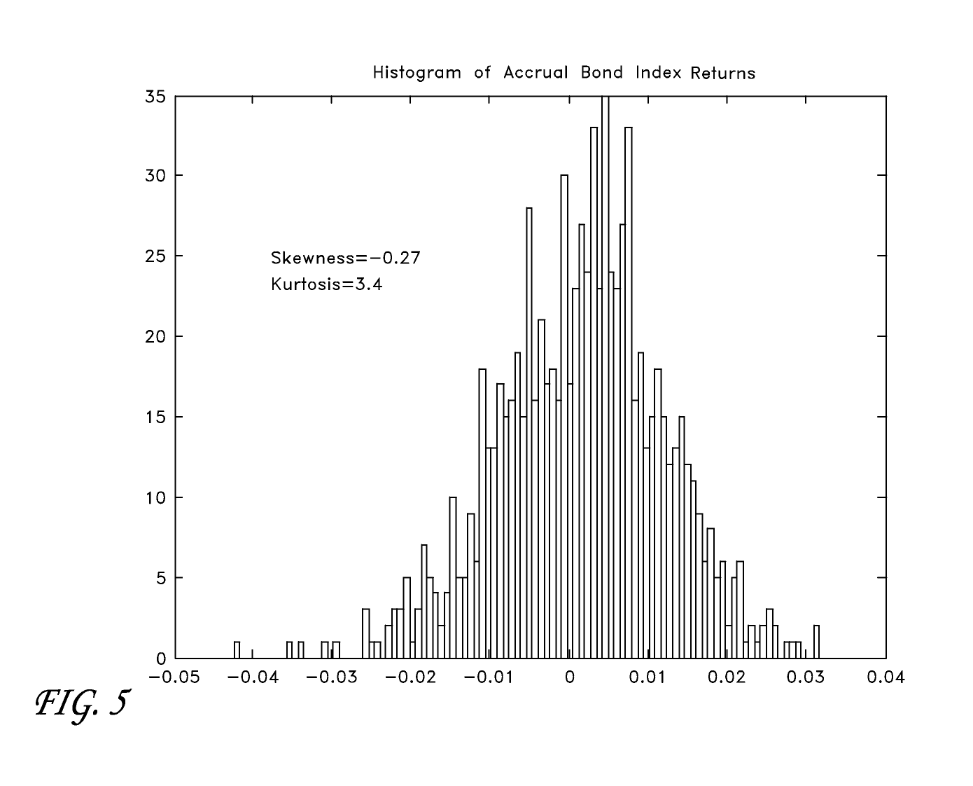

Turning to FIG. 5, a histogram is illustrated that depicts example accrual bond index returns. A Dickey-Fuller test shows that the accrual bond index of certain embodiments not mean-reverting. From the histogram, the distribution of accrual denominator returns of certain embodiments is shown to be very close to a normal distribution. Thus, the accrual denominator of certain embodiments can be modeled in the same way as the equities, i.e. by a Geometric Brownian motion. The stochastic processes for S&P 500 total return index (S) and accrual bond index (B) in the risk-neutral measure are therefore given by:
dS=rSdt+Sσ_{S}dW_{S}
dB=rBdt+Bσ_{B}dW_{B}.
E[dW_{B}dW_{S}]=pdt (40)
Using Ito's lemma we get:

$$ⅆ \frac{S}{B} = \frac{ⅆ S}{B} - \frac{S}{{B}^{2}} ⅆ B + \frac{S}{{B}^{3}} {( ⅆ B )}^{2} - \frac{ρ}{{B}^{2}} ⅆ B ⅆ S . \qquad ( 41 )$$

Thus,

$$\frac{ⅆ \frac{S}{B}}{\frac{S}{B}} = {σ}_{B} ( {σ}_{B} - ρ {σ}_{S} ) ⅆ t + {σ}_{S} ⅆ {W}_{S} - {σ}_{B} ⅆ {W}_{B} . \qquad ( 42 )$$

Define:

$$σ = \sqrt{{σ}_{S}^{2} + {σ}_{B}^{2} - 2 ρ {σ}_{S} {σ}_{B}} . \qquad ( 43 )$$

The ratio of S&P 500 (S) to Accrual Bond Index (B) can be rewritten as:

$$\frac{ⅆ \frac{S}{B}}{\frac{S}{B}} = {σ}_{B} ( {σ}_{B} - ρ {σ}_{S} ) ⅆ t + σ ⅆ W \qquad ( 44 )$$

From equation (44) we see that the ratio index can be also modeled by a Geometric Brownian motion since both its numerator and its denominator follow Geometric Brownian motion.

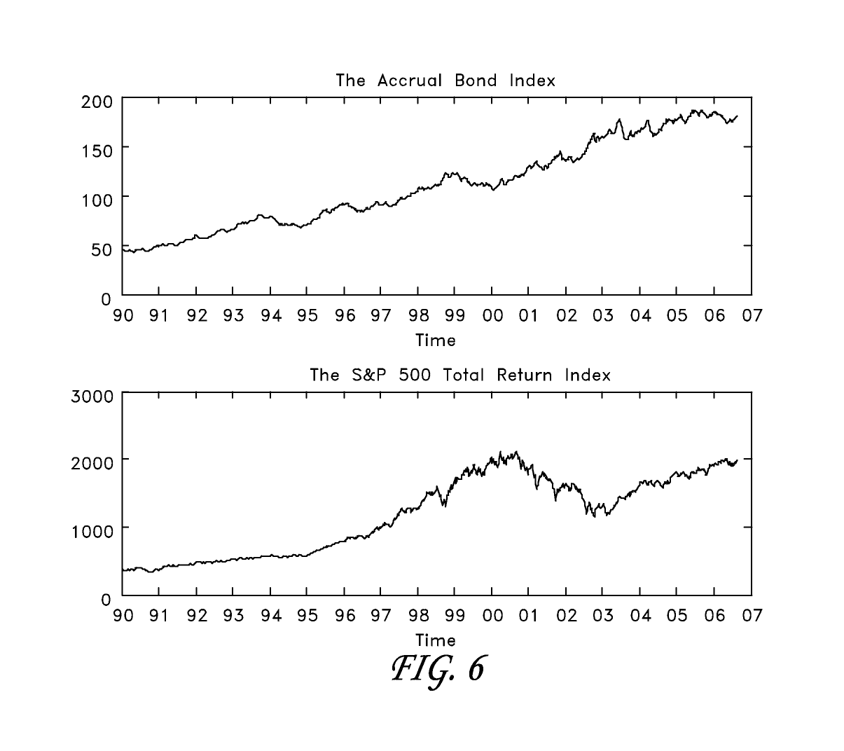

Various statistics illustrate the relative historical performances of the S&P 500 total return index and the ten-year zero-coupon bond over time. Turning now to FIG. 6, a graph is illustrated depicting these historical performance statistics. Table 7 further shows example statistics of the Alternative Ratio Index and its example numerator and denominator. Table 8 illustrates example between the Alternative Ratio Index and its various components.

TABLE 7
Alternative Ratio Index Statistics

| | S&P 500 Total | Ten-Year, | Alternative |
|---|---|---|---|
| | Return Index | Zero-Coupon Bond | Ratio Index |
| Mean | 11.0% | 8.52% | 2.98% |
| Volatility | 14.83% | 7.5% | 16.3% |

TABLE 8
Correlation

| | | Ten-Year, | |
|---|---|---|---|
| | S&P 500 and | Zero-Coupon and | S&P 500 and Ten- |
| | Ratio Index | Ratio Index | Year, Zero-Coupon |
| Correlation | 88.67% | −41.6% | 5.1% |

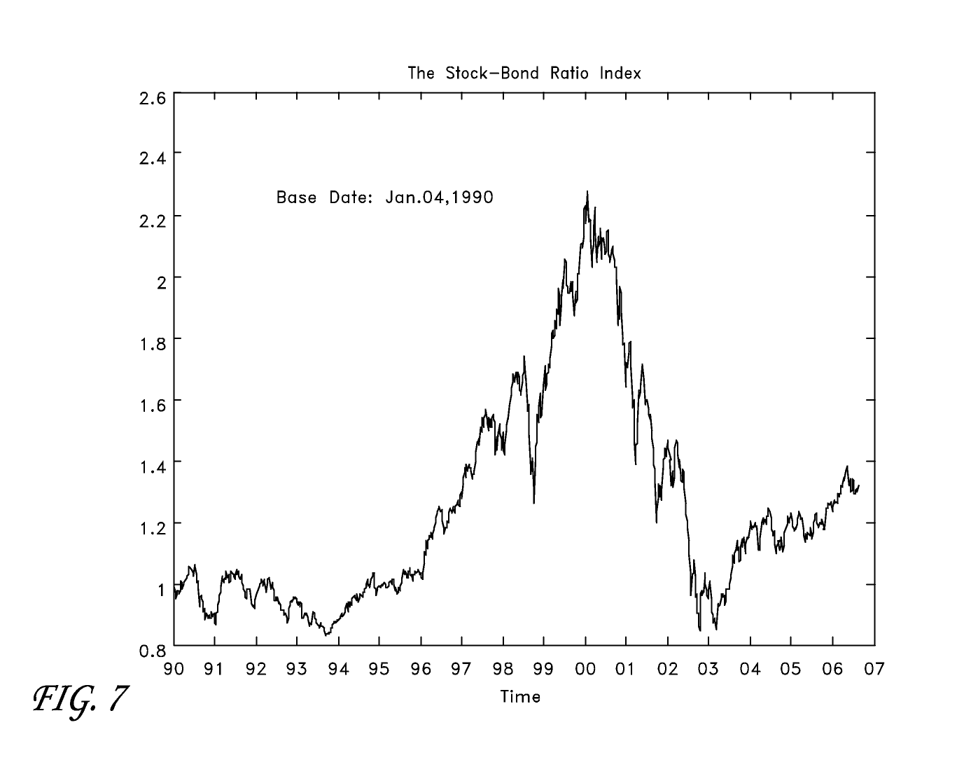

In addition, FIG. 7 illustrates a graph depicting historical performance statistics of an example Alternative Ratio Index.

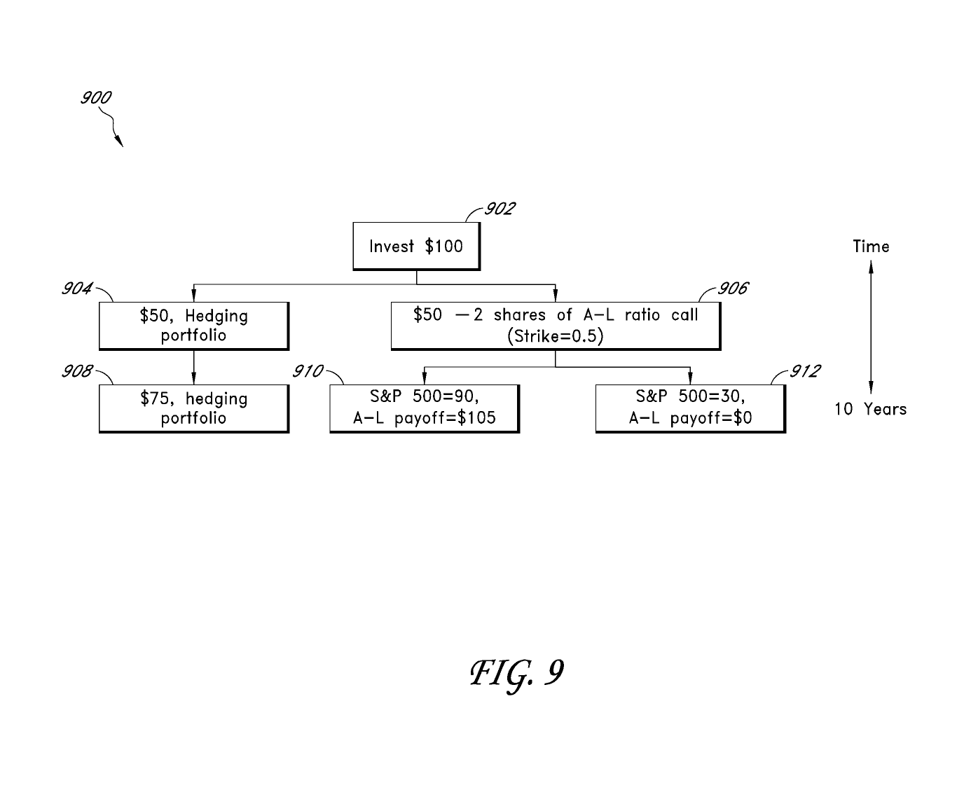

In certain embodiments, the alternative ratio index can be viewed as an asset-liability ratio in the following way. Suppose a company or individual has outstanding debt that is of 10 years duration and that no debt is being repaid. The company or individual can then hedge its debt perfectly by investing in ten-year, zero-coupon bonds. Thus, the accrual denominator D(t) reflects the company's or individual's debt level at time t. Suppose also that this company or individual invests its total assets in the S&P 500 total return index. Then the numerator of the index shows the fluctuation of asset level and the denominator shows the growth of the debt level. The ratio index therefore can indicate the relative performance of investing in the S&P 500 against investing in bonds. Specific examples of tracking this relative performance are described below with respect to FIGS. 8 and 9.

Example Financial Instruments Based on the RST Index

Referring again to FIG. 4, several financial instruments, including derivatives, can be created using the RST Index. Two example instruments described in further detail herein include European options and asset-liability options.

Regarding the European option, define α=σ_{B}(σ_{B}−ρσ_{S}), and

$${R}_{t} = \frac{{S}_{t}}{{B}_{t}} .$$

We can use the following formula (45) to value the call option for the alternate ratio index:

$$\begin{matrix}c = {ⅇ}^{- rT} {E}^{Q} [ max ( {R}_{T} - k , 0 ) ] = {R}_{0} {ⅇ}^{( α - r ) T} N ( {d}_{1} ) - K {ⅇ}^{- rT} N ( {d}_{2} ) & ( 45 ) \\ {d}_{1} = \frac{ln ( {R}_{0} {ⅇ}^{α T} / K )}{σ \sqrt{T}} + \frac{1}{2} σ \sqrt{T} , and {d}_{2} = {d}_{1} - σ \sqrt{T} & ( 46 )\end{matrix}$$

where c is a European call option value on the alternate ratio index struck in K, r is the constant risk free rate, R₀ is the initial ratio index, and Q denotes the risk neutral measure. Since the alternate ratio index does not have a unit in this implementation, a call option on the alternate ratio index is also unit free. Thus, in designing option contracts, we can assign an appropriate unit to the underlying ratio index, and hence the option should have the same unit with the ratio index.

Another example financial instrument is an asset-liability option. The payoff of an asset-liability call option can be defined as:

$$payoff = {B}_{T} max ( \frac{{S}_{T}}{{B}_{T}} - X , 0 ) , \qquad ( 47 )$$

where S_{T} is the S&P 500 total return index at time T, X is a strike price (which may be different from K), and B_{T} is the accrual denominator at time T. Thus, if at expiration the option ends up in the money, the option owners, instead of receiving

$$\frac{{S}_{T}}{{B}_{T}} - X$$

dollars, can receive

$$\frac{{S}_{T}}{{B}_{T}} - X$$

shares of ten-year, zero-coupon bond, or an equivalent amount of

$$( \frac{{S}_{T}}{{B}_{T}} - X ) {B}_{T}$$

dollars. The payoff of the Asset Liability options in general can be in the form of any asset or combination of assets including cash.

Equation (47) can be re-written as:
payoff=max(S_{T}−XB_{T},0). (48)
The strike price X can be determined by the asset to liability ratio (see, e.g., FIG. 9). The asset liability option's price can be calculated by using the following formula (49):

$$\begin{matrix}c = {S}_{0} N ( {d}_{1} ) - {XB}_{0} N ( {d}_{2} ) & ( 49 ) \\ {d}_{1} = \frac{ln ( \frac{{S}_{0}}{{XB}_{0}} )}{σ \sqrt{T}} + \frac{1}{2} σ \sqrt{T} , and {d}_{2} = {d}_{1} - σ \sqrt{T} & ( 50 )\end{matrix}$$

where

$$σ = \sqrt{{σ}_{S}^{2} + {σ}_{B}^{2} - 2 ρ {σ}_{S} {σ}_{B}} .$$

Using put-call parity one can determine prices for asset-liability put options.

For example, suppose the initial stock price S₀=$1 and the bond price B₀=$1. Table 9 shows example asset-liability call option prices with different strike prices and time to expiration.

TABLE 9
Example Asset-Liability Option Prices

| | Strike | | | | |
|---|---|---|---|---|---|
| | $0.8 | $0.9 | $1 | $1.1 | $1.2 |
| Option price (t = 10) | $0.2993 | $0.2469 | $0.2031 | $0.1669 | $0.1370 |
| Option price (t = 1) | $0.2057 | $0.1241 | $0.0649 | $0.0294 | $0.0117 |

Derivative financial instruments on the ratio index (RST, Alternative, or other types) of certain embodiments cannot be replicated by statically buying or selling any existent securities (including S&P 500 stocks, ten-year bonds, S&P 500 options, bond options, or the like). Theoretically, the asset-liability option can be replicated by continuously rebalancing S&P 500 (or options) and bond (or options) portfolios, but practically, it is not feasible to do so because of high transaction costs. Thus, the creation of ratio index derivatives can improve the existent asset liability strategies.

FIG. 8 illustrates a flowchart diagram depicting an example investment portfolio 800 employing an embodiment of a ratio index over time. In an embodiment, either the RST Index of the Alternative Ratio Index may be used in the example depicted. In addition, in certain embodiments, other ratio indices could also be used.

In the portfolio 800, an investor, “Investor A,” initially has $60 in hand (see 802). Investor A also has an ongoing liability which has a present value of $50 and a duration which remains at 10 years. In the context of a pension fund, for example, the debt can remain at 10 years when there are both new entrants and departing persons in the fund such that duration of pension liabilities remains roughly constant as time passes.

Investor A's asset-liability ratio is 6:5. He considers two strategies of investing his money: 1) invest his money in the S&P 500 index, or 2) invest his money in bonds. If he invests his money in an S&P 500 index, he may be afraid that he might lose a lot of money and may not be able to repay his debt. A conservative strategy could be to invest his money in bonds, but he also wants to have some upside potential.

Thus, the strategy depicted in the example portfolio 800 is to invest $50 out of $60 in ten-year, zero-coupon bonds (the hedging portfolio at 804) following the rolling strategy as outlined above with respect to FIG. 4. He can then use the extra $10 to buy an asset-liability call option expiring in 10 years (supposing that he wants to rebalance his position in 10 years time) with strike price of 1 (see 806). The choice of strike price is explained below with respect to FIG. 9. At present (year 1), suppose the S&P 500 total return index is $50.

After ten years, suppose the S&P 500 total return index is at $90 (see 870) and his hedging bond portfolio (liability) changes to $75 (see 808). Because the ratio of $90 to $75 is greater than the strike price of 1, the asset-liability payoff in this case, calculated by either equation (35) or (48), is $15 ($15=90−1*75). Thus, Investor A's portfolio is worth the sum of the hedging portfolio and the payoff, which is $90. However, if after ten years, the S&P 500 total return index is at 70 (at 872), the payoff is zero because the ratio of 70 to 75 is less than the strike price of 1. Hence, at 872 his portfolio is only worth $75.

Thus, after 10 years the payoff of Investor A's portfolio is max(S,B); that is, either the proceeds of investing in S&P 500 (assets) or the those of investing in bonds. Consequently, the portfolio A tracked Investor A's relative balance of assets and liabilities.

FIG. 9 illustrates a flowchart diagram depicting another example investment portfolio 900 employing an embodiment of a ratio index. In an embodiment, either the RST Index of the Alternative Ratio Index may be used in the example. In addition, in certain embodiments, other ratio indices could also be used.

In the portfolio 900, an investor, “Investor B,” initially has $100 in hand (see 902). Suppose Investor B, like Investor A, has an ongoing liability which has a present value of $50 and a duration which always remains at 10 years. Thus, his asset to liability ratio is 2:1. He wants to spend $50 in the liability hedging portfolio and invest the rest in asset-liability options. Thus, he invests $50 in asset-liability options (see 906) with 10 years maturity and strike price 0.5. If the asset-liability option is based on the Alternative Ratio Index, for example, by equation (49) each asset-liability option is $25. Thus, Investor B buys two asset-liability options ($2×$25=$50).

At present (year 1), the S&P 500 total return index is $50 (see 906). After ten years, suppose that the S&P 500 total return index is $90 (see 910) and the hedging portfolio changes to $75 (see 908). The asset-liability payoff in this case, calculated by either equation (35) or (48), is $105 ($105=2×(90−0.5*75)). Investor B therefore ends up with $180 ($180=$75+$105, which is also equivalent to $180=2×$90). If instead the S&P 500 total return index is $20, Investor B ends up having $75. Thus, the payoff of Investor B's portfolio is 2×max(S, B/2)=max(2S,B).

From the above two examples (FIG. 8 and FIG. 9), we can see that Investor A and Investor B choose different strike prices because they have different asset and liability ratios. The strike price can be chosen such that the payoff of the portfolio is max(kS,B), where k is the number of asset-liability options invested.

In the above two examples, if Investors A and B buy the S&P 500 options instead of the asset-liability options, their total payoff would be B+a×max(S−K,0), where a is the number of vanilla S&P 500 call options that Investors A or B buys and K is the strike. Both Investors A and B are now exposed to a strike selection risk, i.e. they would not know which strike to buy at. This strike selection risk can be greatly amplified if the total portfolio is rebalanced frequently. Also, from either equation (35) or (48), we see that the asset-liability option can be considered as a vanilla option with stochastic strike that grows at the risk neutral rate. Thus, the asset-liability option can be cheaper than the S&P 500 index option, especially for long-term options.

The asset-liability option can also be close to the spread option (also known as better-to-buy options) in certain embodiments, but the asset-liability option can have better characteristics in the use of hedging liabilities as illustrated above. This can be seen by considering the payoff of a spread option, given by
payoff=max(S_{T}−B_{T}−K,0), (51)
where K is the strike. Investor B in example 2 cannot hedge his exposure by using a typical spread option (see Equation (35)), because he cannot choose a K to achieve the portfolio with payoff max(kS,B). Thus, the asset-liability option can be better than the traditional spread option in the area of asset-liability management. Asset-liability ratio options can therefore be useful instruments in the Asset-Liability Management (ALM) or Liability Driven Investment (LDI) field.

Another example (not shown) of an investment portfolio is that of a portfolio run by a pension fund manager. Assume that the fund manager finds that the duration of his liability is smooth and 10 years. Thus, he can utilize 1 share of 10 year zero coupon bonds to hedge the liability and roll the contract over time. But the fund manager may also want to have some upside potential. Thus, the fund manager can buy a asset-liability option with a certain strike. Assuming that the fund has $100 at time zero, the following equation may be solved to calculate which asset-liability option strike to buy:

$$g = \frac{( 100 - g )}{{S}_{0}} F ( \frac{{S}_{0}}{{P}_{0}} , \frac{{S}_{0}}{( 100 - g )} ) , \qquad ( 52 )$$

where g is the money paid in order to buy the asset-liability option and F(a,b) is the function of the asset-liability call option with the starting value S₀/P₀ and strike price

$$\frac{{S}_{0}}{100 - g} .$$

Since S₀ are P₀ are known, in an embodiment, an option can be created with price

$$\frac{g {S}_{0}}{100 - g}$$

and strike S₀/(100−g). Thus, at the option maturity, the payoff function is:

$$\begin{matrix}payoff = \frac{( 100 - g )}{{S}_{0}} \times {P}_{T} max ( \frac{{S}_{T}}{{P}_{T}} - \frac{{S}_{0}}{100 - g} , 0 ) \\ = \frac{( 100 - g )}{{S}_{0}} \times max ( {S}_{T} - \frac{{S}_{0}}{100 - g} {P}_{T} , 0 ) \\ = max ( \frac{( 100 - g )}{{S}_{0}} \times {S}_{T} - {P}_{T} , 0 ) \\ = max ( \frac{( 100 - g ) {S}_{T}}{{S}_{0}} - {P}_{T} , 0 ) .\end{matrix} \qquad ( 53 )$$

Thus, the fund ends up with either

$$\frac{( 100 - g ) {S}_{T}}{{S}_{0}} or {P}_{T} .$$

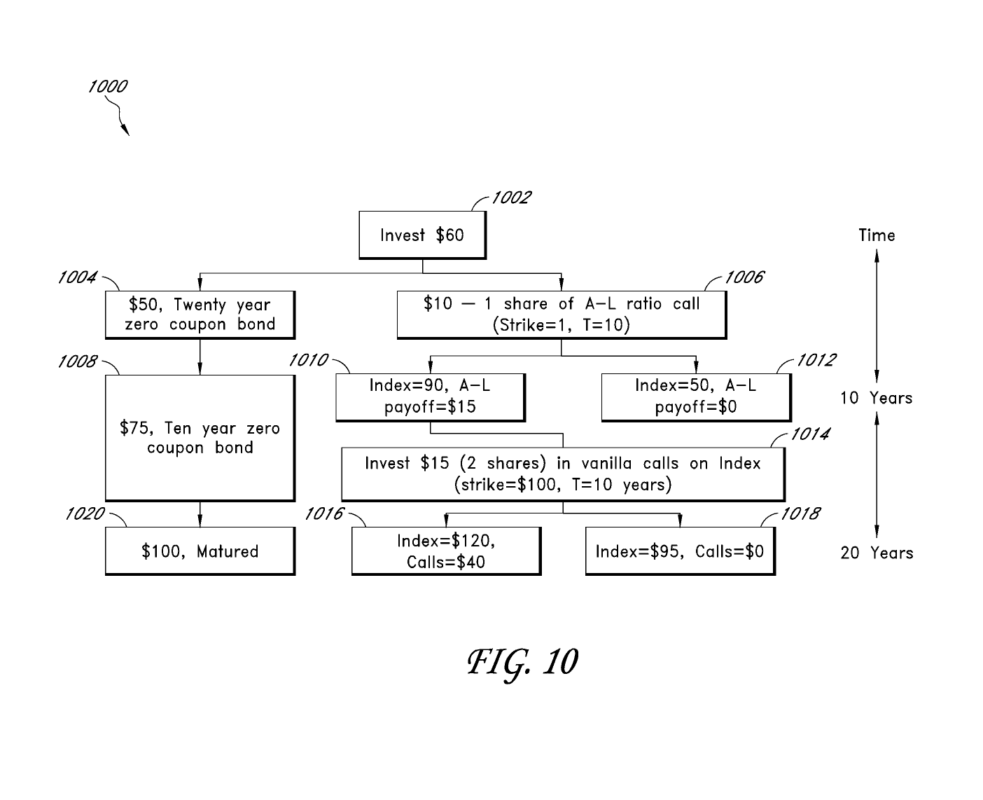

FIG. 10 illustrates a flowchart diagram depicting another example investment portfolio 1000 employing an embodiment of a ratio index. In an embodiment, either the RST Index of the Alternative Ratio Index may be used in the example. In addition, in certain embodiments, other ratio indices could also be used.

In the depicted example, Investor A has a $100 liability in twenty years time. He has $60 in hand (see 1002). He wants to rebalance his portfolio in ten years time. Thus, he buys 1 share of twenty year zero coupon bonds at $50 (see 1004) and buys an asset-liability option in 10 years maturity at $10 (see 1006) with strike price 1. At that time, suppose the S&P 500 total return index is $50. After ten years, suppose the stock price is $90 (see 1010) and the zero coupon bond price (at that time a ten year zero coupon bond) changes to $75 (see 1008). According to the payoff equations described above, Investor A ends up with $90 ($90=$75+$15). Otherwise, if the stock price is $50 (see 1012), then Investor A ends up with only $75.

Then he may continue to invest the 10 year zero coupon bond at $75 (see 1008), and buy 2 shares at $7.50 each (see 1014) of 10 year vanilla call options (not asset-liability ratio options) on an S&P 500 index with strike $100. If the stock price at twenty years is $70 (less than the zero coupon bond price), Investor A ends up only having $100; otherwise, he ends up with $140 ($120=$100+$40). Thus he has to put his $75 in bonds in order to hedge his $100 liability, yet has upside potential of $140.

FIG. 11 illustrates a block diagram of an example computer system 1100. The computer system 1100 system of various embodiments facilitates calculating ratio indices, creating derivatives, obtaining financial parameters and their prices from remote systems 1120 over a communications medium 1112 such as the Internet or the like, and publishing ratio indices and related derivative prices over the communications medium 1112 to remote systems 1120.

Illustrative computer systems 1100 include general purpose (e.g., PCs) and special purpose (e.g., graphics workstations) computer systems. More generally, any processor-based system may be used as a computer system 1100.

The computer system 1100 of certain embodiments includes a processor 1102 for processing one or more software programs 1106 stored in memory 1104, for accessing data stored in hard data storage 1108, and for communicating with a network interface 1110. The network interface 1110 provides an interface to the communications medium 1112 and/or other networks.

In an embodiment, the computer system 1100 calculates ratio indices, creates and prices financial instruments, and the like. The computer system 1100 comprises, by way of example, one or more processors, program logic, or other substrate configurations representing data and instructions, which operate as described herein. In other embodiments, the processor can comprise controller circuitry, processor circuitry, processors, general purpose single-chip or multi-chip microprocessors, digital signal processors, embedded microprocessors, microcontrollers and the like.

The computer system 1100 can further communicate via the communications medium 1112 with one or more remote systems 1120 using the network interface 1110 to obtain prices and indices relevant to the creation of ratio indices and financial instruments. In other embodiments, the network interface 1110 or the communications medium 1112 can be any communication system including by way of example, dedicated communication lines, telephone networks, wireless data transmission systems, two-way cable systems, customized computer networks, interactive kiosk networks, automatic teller machine networks, interactive television networks, and the like.

In addition, the computer system 1100 can publish ratio indices and financial instrument prices to the remote systems 1120. Wide ranges of offerings are available to consumers by accessing information with the remote systems 1120. In one embodiment, the remote systems 1120 are websites on the World Wide Web. In other embodiments the remote systems 1120 can be any device that interacts with or provides data, including by way of example, any internet site, private networks, network servers, video delivery systems, audio-visual media providers, television programming providers, telephone switching networks, teller networks, wireless communication centers and the like.

Each of the processes and algorithms described above may be embodied in, and fully automated by, code modules executed by one or more computers or computer processors. The code modules may be stored on any type of computer-readable medium or computer storage device. The processes and algorithms may also be implemented partially or wholly in application-specific circuitry. The results of the disclosed processes and process steps may be stored, persistently or otherwise, in any type of computer storage. In one embodiment, the code modules may advantageously be configured to execute on one or more processors. In addition, the code modules may comprise, but are not limited to, any of the following: software or hardware components such as software object-oriented software components, class components and task components, processes methods, functions, attributes, procedures, subroutines, segments of program code, drivers, firmware, microcode, circuitry, data, databases, data structures, tables, arrays, variables, or the like.

The various features and processes described above may be used independently of one another, or may be combined in various ways. All possible combinations and subcombinations are intended to fall within the scope of this disclosure. In addition, certain method or process steps may be omitted in some implementations.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer-implemented method of creating a financial instrument, the method comprising:
providing a first value representing at least a Standard and Poor's (S&P) 500 total return index;
providing a second value representing at least a ten year zero coupon bond price; and
creating an asset-liability option having an underlying comprising the ratio index, the asset-liability option comprising a payoff calculated according to the formula:
Payoff=S_{T}−XP_{T},
wherein S_{T} represents a S&P 500 total return index at time T;
P_{T} represents the ten year zero coupon bond price at time T;
X represents a strike price of the asset-liability option; and
wherein Payoff is greater than or equal to zero.

2. The method of claim 1, further comprising pricing the asset-liability option based at least in part on the ratio index, the ratio index represented by a formula:
$${Z}_{T} = \frac{{S}_{T}}{{P}_{T}} = exp [ \begin{matrix}ln ( \frac{{S}_{0}}{{P}_{0}} ) + ( Ck θ - \frac{1}{2} {σ}_{s}^{2} ) T + ( 1 - Ck ) \\ [ {r}_{0} \frac{1 - {ⅇ}^{- kT}}{k} + θ ( T - \frac{1 - {ⅇ}^{- kT}}{k} ) ] + \\ {σ}_{r} {\int }_{0}^{T} \frac{1 - {ⅇ}^{- k ( T - t )} + Ck {ⅇ}^{- k ( T - t )}}{k} ⅆ {W}_{r} + \\ {σ}_{s} {\int }_{0}^{T} ⅆ {W}_{s}\end{matrix} ] ,$$
wherein Z_{T} represents the ratio index at time T;
S_{T} represents the S&P 500 total return index at time T;
P_{T} represents the ten year zero coupon bond price at time T;
exp represents an exponential function;
S₀ represents the S&P 500 total return index at time T=0;
P₀ represents the ten year zero coupon bond price at time T=0;
k represents a mean reverting speed of a short interest rate;
C represents a constant according to a formula
$$C = \frac{1 - exp ( - k τ )}{k} ,$$
where τ represents time to maturity;
θ represents a long-run mean;
σₛ represents volatility of the S&P 500 index;
r₀ represents drift of the S&P 500 index at time T=0;
σᵣ represents volatility of the ten year zero coupon bond price;
Wₛ represents a wiener process with respect to S_{T}; and
Wᵣ represents a wiener process with respect to P_{T}.

3. A computer-implemented method of comparing financial parameters, the method comprising:
providing a first value representing at least a first financial parameter;
providing a second value representing at least a second financial parameter; and
calculating in a computer a ratio index comprising a time sequence of the ratio of the first value to the second value.

4. The method of claim 3, wherein the first financial parameter comprises a stock index, and wherein the second financial parameter comprises a bond index.

5. The method of claim 3, wherein the first financial parameter comprises a stock index, and wherein the second financial parameter comprises a bond price.

6. The method of claim 3, wherein the first financial parameter comprises a Standard and Poor's (S&P) 500 total return index, and wherein the second financial parameter comprises a ten year zero coupon bond price.

7. The method of claim 6, further comprising pricing a financial instrument based at least in part on the ratio index, the ratio index represented by a formula:
$${Z}_{T} = \frac{{S}_{T}}{{P}_{T}} = exp [ \begin{matrix}ln ( \frac{{S}_{0}}{{P}_{0}} ) + ( Ck θ - \frac{1}{2} {σ}_{s}^{2} ) T + ( 1 - Ck ) \\ [ {r}_{0} \frac{1 - {ⅇ}^{- kT}}{k} + θ ( T - \frac{1 - {ⅇ}^{- kT}}{k} ) ] + \\ {σ}_{r} {\int }_{0}^{T} \frac{1 - {ⅇ}^{- k ( T - t )} + Ck {ⅇ}^{- k ( T - t )}}{k} ⅆ {W}_{r} + \\ {σ}_{s} {\int }_{0}^{T} ⅆ {W}_{s}\end{matrix} ] ,$$
wherein Z_{T} represents the ratio index at time T;
S_{T} represents the S&P 500 total return index at time T;
P_{T} represents the ten year zero coupon bond price at time T;
exp represents an exponential function;
S₀ represents the S&P 500 total return index at time T=0;
P₀ represents the ten year zero coupon bond price at time T=0;
k represents a mean reverting speed of a short interest rate;
C represents a constant according to a formula
$$C = \frac{1 - exp ( - k τ )}{k} ,$$
where τ represents time to maturity;
θ represents a long-run mean;
σₛ represents volatility of the S&P 500 index;
r₀ represents drift of the S&P 500 index at time T=0;
σᵣ represents volatility of the ten year zero coupon bond price;
Wₛ represents a wiener process with respect to S_{T}; and
Wᵣ represents a wiener process with respect to P_{T}.

8. The method of claim 3, further comprising creating a derivative financial instrument having an underlying comprising the ratio index.

9. The method of claim 8, wherein the derivative financial instrument comprises at least one of the following: a call option, a put option, a range option, a collar option, a straddle option, a digital option, a European option, an American option, and an asset-liability option.

10. The method of claim 8, wherein the derivative financial instrument comprises an asset-liability option, the asset-liability option comprising a payoff calculated according to the formula:
Payoff=S_{T}−XP_{T},
wherein S_{T} represents a S&P 500 total return index at time T;
P_{T} represents the ten year zero coupon bond price at time T;
X represents a strike price of the asset-liability option; and
wherein Payoff is greater than or equal to zero.

11. The method of claim 3, wherein the first financial parameter comprises a Standard and Poor's (S&P) 500 total return index, and wherein the second financial parameter comprises an accrual bond index.

12. A computer-implemented method of creating a financial instrument, the method comprising:
providing a first value representing at least a first parameter;
providing a second value representing at least a second parameter;
calculating in a computer a ratio index comprising a time sequence of the ratio of the first value to the second value; and
creating a financial instrument, wherein the price of the financial instrument is based at least in part on the ratio index.

13. The method of claim 12, wherein the first parameter comprises a stock index, and wherein the second parameter comprises a bond price.

14. The method of claim 12, wherein one or more of the first and second parameters comprises a ratio index.

15. The method of claim 12, wherein one or more of the first and second parameters comprises an economic indicator.

16. The method of claim 15, wherein the economic indicator comprises an unemployment rate.

17. The method of claim 12, wherein the financial instrument comprises an asset-liability derivative having an underlying comprising the ratio index.

18. The method of claim 12, wherein the financial instrument comprises at least one of the following: a call option, a put option, a range option, a collar option, a straddle option, a digital option, a European option, and an American option.

19. The method of claim 12, wherein the first parameter comprises a Standard and Poor's (S&P) 500 total return index, and wherein the second parameter comprises a ten year zero coupon bond price.

20. The method of claim 19, further comprising pricing the financial instrument based at least in part on the ratio index, the ratio index represented by a formula:
$${Z}_{T} = \frac{{S}_{T}}{{P}_{T}} = exp [ \begin{matrix}ln ( \frac{{S}_{0}}{{P}_{0}} ) + ( Ck θ - \frac{1}{2} {σ}_{s}^{2} ) T + ( 1 - Ck ) [ \begin{matrix}{r}_{ 0} \frac{1 - {ⅇ}^{- kT}}{ k} + \\ θ ( T - \frac{1 - {ⅇ}^{- kT}}{ k} )\end{matrix} ] + \\ {σ}_{r} {\int }_{0}^{T} \frac{1 - {ⅇ}^{- k ( T - t )} + Ck {ⅇ}^{- k ( T - t )}}{k} ⅆ {W}_{r} + {σ}_{s} {\int }_{0}^{T} ⅆ {W}_{s}\end{matrix} ] ,$$
wherein Z_{T} represents the ratio index at time T;
S_{T} represents the S&P 500 total return index at time T;
P_{T} represents the ten year zero coupon bond price at time T;
exp represents an exponential function;
S₀ represents the S&P 500 total return index at time T=0;
P₀ represents the ten year zero coupon bond price at time T=0;
k represents a mean reverting speed of a short interest rate;
C represents a constant according to a formula
$$C = \frac{1 - exp ( - k τ )}{k} ,$$
where τ represents time to maturity;
θ represents a long-run mean;
σₛ represents volatility of the S&P 500 index;
r₀ represents drift of the S&P 500 index at time T=0;
σᵣ represents volatility of the ten year zero coupon bond price;
Wₛ represents a wiener process with respect to S_{T}; and
Wᵣ represents a wiener process with respect to P_{T}.

21. The method of claim 12, wherein the first financial parameter comprises a Standard and Poor's (S&P) 500 index, and wherein the second financial parameter comprises an accrual bond index.

22. A computer-implemented method of creating a financial instrument, the method comprising:
providing a first value representing at least a first parameter;
providing a second value representing at least a second parameter;
calculating in a computer a ratio index comprising a time sequence of the ratio of the first value to the second value; and
creating an asset-liability option having an underlying comprising the ratio index.

23. The method of claim 22, wherein the first parameter comprises a stock index, and wherein the second parameter comprises a bond index.

24. The method of claim 22, wherein the first parameter comprises a stock index, and wherein the second parameter comprises a bond price.

25. The method of claim 22, wherein the payoff of the asset-liability option is calculated according to the formula:
Payoff=S_{T}−XP_{T},
wherein S_{T} represents a S&P 500 total return index at time T;
P_{T} represents the ten year zero coupon bond price at time T;
X represents a strike price of the asset-liability option; and
wherein Payoff is greater than or equal to zero.
